(19) United States
(12) Patent Application Publication
(10) Pub. No.: US 2013/0335701 A1
(43) Pub. Date: Dec. 19, 2013

(54) LENSES, SYSTEMS AND METHODS FOR PROVIDING CUSTOM ABERRATION TREATMENTS AND MONOVISION TO CORRECT PRESBYOPIA

(71) Applicant: AMO Groningen B.V., (US)

(72) Inventors: Carmen Canovas Vidal, Groningen (NL); Patricia Ann Piers, Groningen (NL); Hendrik A. Weeber, Groningen (NL)

(73) Assignee: AMO Groningen B.V., Netherlands (NL)

(21) Appl. No.: 13/690,505

(22) Filed: Nov. 30, 2012

Related U.S. Application Data
(60) Provisional application No. 61/565,831, filed on Dec. 1, 2011.

(51) Int. Cl. G02C 7/02

(52) U.S. Cl. CPC G02C 7/028
USPC 351/159.77; 351/159.74

(57) ABSTRACT

A lens, system and/or method for providing custom ocular aberrations for enhanced higher visual acuity. Scaled versions of a patient's aberration pattern may either attenuate or amplify the overall amount of ocular aberrations, to either correct or partially correct a patient's aberrations leading to enhanced visual acuity and/or extended depth of focus. This may be binocularly applied in order to provide high visual acuity in a patient at least at near, far and intermediate distances. The method may include obtaining an optimized binocular summation of both eyes of the patient; designing a first lens solution to correct or partially correct the dominant eye's aberrations according to an attenuated scaled version of a patient's ocular aberrations in the dominant eye; and designing a second lens solution to provide an additional customized extension of depth of focus by the induction of scaled patterns of ocular aberrations in the non dominant eye.

### CLAIM OF PRIORITY

The present application claims priority under 35 U.S.C §119(e) to provisional application No. 61/565,831, filed on Dec. 1, 2011 under the same title, which is incorporated herein by reference in its entirety. Full Paris Convention priority is hereby expressly reserved.

### BACKGROUND OF THE INVENTION

1. Field of the Invention

This invention relates generally to correction of eye defects, and more specifically, to a system, method and apparatus for providing custom aberration treatments and/or customized monovision for the treatment of presbyopia.

2. Description of the Related Art

Surgery on the human eye has become commonplace in recent years. Many patients pursue eye surgery as an elective procedure to treat an adverse eye condition, such as to avoid the use of contacts or glasses. Such adverse conditions may include, for example, presbyopia, as well as other conditions known to those skilled in the art that may negatively affect elements of the eye. More particularly, presbyopia comprises the lack of capability of the eye lens to accommodate or bend and thus to see at far distance and at near distance. Presbyopia is a particularly common problem induced by age and/or pseudophakia (a condition in which an aphakic eye has been fitted with an intraocular lens to replace the crystalline lens).

The anatomy and physiology of the human eye is well understood. Generally speaking, the structure of the human eye includes an outer layer formed of two parts, namely the cornea and the sclera. The middle layer of the eye includes the iris, the choroid, and the ciliary body. The inner layer of the eye includes the retina. The phakic eye also includes, physically associated with the middle layer, a crystalline lens that is contained within an elastic capsule, also referred to as the lens capsule, or capsular bag. Image formation in the eye occurs by entry of image-forming light into the eye through the cornea, and refraction by the cornea and the crystalline lens to focus the image-forming light on the retina. The retina provides the light sensitive tissue of the eye.

Ophthalmic lenses, such as intraocular lenses (IOLs), phakic IOLs and corneal implants, may be used to enhance or correct vision, such as to correct for the aforementioned adverse conditions, including aberrations or inadequacies that negatively affect the performance of the referenced structures of the eye. For example, IOLs are routinely used to replace the crystalline lens of an eye removed during cataract surgery.

By way of example, an ophthalmic lens in the form of an IOL may be spheric or toric. Spheric IOLs are used to correct of a myriad of vision problems, while toric IOLs are typically used for astigmatic eye correction. Generally, astigmatism is an optical defect in which vision is blurred due to the ocular inability to sharply focus a point object on the retina. This may be due to an irregular, or toric, curvature of the cornea and/or eye lens.

Ophthalmic lenses, such as IOLs, may be, for example, refractive or diffractive, and may be monofocal, multifocal, or may include monofocal and multifocal portions. More particularly, a monofocal IOL portion may provide a single focal point, whereas a multifocal IOL portion may provide multiple focal points for correction of vision at different distances. For example, a bifocal IOL may provide two different focal points, for near or intermediate vision, and distant vision.

By way of non-limiting example, such a bifocal lens may include zones, wherein the optical power in various zones may vary. In such a lens, the upper and central portion of the optic may be used for distance vision, while the optical add power may be constrained to the lower portion of the lens, as would be the case for a bifocal spectacle lens.

Bifocal IOLs may also be comprised of zones, typically annular, which produce a first focal point for distant vision and a second focal point corresponding to near distances. A disadvantage associated with this type of bifocal IOL is halos, wherein the unused foci creates an out-of-focus image that is superimposed on the used foci, in part due to the abrupt change in optical power between adjacent zones.

In refractive laser surgery, “presbyopia correction” was first reported in the early 1990s (See Moreira H, Garbus J J, Fasano A, Clapham L M, Mc Donnell P J; Multifocal Corneal Topographic Changes with Excimer Laser photorefractive Keratectomy; Arch Ophthalmol 1992; 100: 994-999; Anschutz T, Laser Correction for Hyperopia and Presbyopia, Int Ophthalmol Clin 1994; 34: 105-135). Moreover, a number of lens designs have been used in an attempt to correct for the patient's presbyopia, including the exemplary bifocal IOL discussed above. For example, among the many known approaches to presbyopia are bifocal and progressive spectacle lenses, extended depth of focus lenses, corneal inlays, monovision lenses, the afore-discussed multifocal/bifocal contact or intraocular lenses, and accommodative intraocular lenses. None of these approaches are capable of fully restoring accommodation, but all represent compromises to provide a fair near distance vision, typically at some cost to far and/or intermediate distance vision.

The visual system has been shown to be adapted to the individual's ocular aberrations. By using adaptive optics, Artal et al. (Journal of Vision (2004) 4, 281-287) showed that subjects are perceived sharper when looking through their own aberrations than when seen through a rotated version of them. This indicates a neural mechanism that compensates for the blur that natural aberrations generate in the eye and what is not present when some other aberration pattern is imposed. The fact that natural aberration degrades less visual perception can also be used to extend depth of focus while minimally degrading the overall visual performance, as is herein shown.

Another strategy to solve presbyopia is related to monovision. It is based on the principle of binocular vision, and as such provides one lens that corrects the wearer's distant vision acuity and which is for use on or implanted into the dominant eye (the eye that predominates for the individuals' distant vision), and a second lens that corrects the wearer's near vision acuity and that is thus placed on or in the non-dominant eye. More particularly in a monocular IOL embodiment, the “far eye” is typically implanted with the IOL power that retrieves no refractive error at far distance, and the “near eye” is typically implanted with an IOL power that is increased over that of the “far eye,” such as an increase in power of between +1 and +2D.

However, such a lens design in a monocular embodiment has proven suboptimal for a variety of reasons. Principle among these reasons is that intermediate vision is typically sacrificed in order to achieve acceptable near and far vision. If intermediate vision is not sacrificed, then most typically near vision suffers. Furthermore, such lenses are typically limited in the optical aberrations that may be corrected, often leaving significant aberrations of the lens wearer, such as higher order aberrations, uncorrected.

Thus, a need exists for a lens apparatus, system and method that provides custom aberration treatments and/or customized monovision to correct presbyopia and provide improved vision at all of near, far and intermediate distances.

### SUMMARY OF THE INVENTION

The present invention is and includes at least an apparatus, such as lenses, systems and methods for providing an ophthalmic solution with scaled patterns of natural patient's aberrations. Natural aberrations can be amplified in order to extended depth of focus or may be attenuated, in order to correct or partially correct eye aberrations. This amplification/attenuation is performed by keeping a scaled version of natural eye's aberration, in order to profit from patient's neural adaptation.

Another aspect of the present invention is to use the previous concept to induce customized monovision binocularly, to thereby provide high visual acuity in a patient at least at near, far and intermediate distances. The apparatus, system and method may include obtaining an optimized binocular summation of both eyes of the patient. This optimized binocular summation is composed of a lens solution which may be, for example, intraocular lenses (IOLs), phakic IOLs, contact lenses, spectacle lenses, and corneal inlays, as well as corneal reshaping procedures, such as laser and similar therapies, and combinations thereof.

The lens solution provides the correction or partial correction of the natural eye's aberration according to an attenuation of a patient's ocular aberrations in the dominant eye. The binocular vision is enhanced by an additional lens solution which allows for the induction of scaled patterns of natural non dominant eye aberrations, in order to increase depth of focus in that eye. The system herein proposed allows for excellent optical performance for far distance, because all pertinent ocular aberrations are corrected or partially corrected in the dominant eye, as well as an extension of the depth of focus with a minimal impacting on vision performance, because it is provided by a scaled version of natural aberrations, to which the subject is neurally adapted.

In an alternative embodiment, the extension of depth of focus is further enhanced by the addition of some defocus, that may also be customized, and/or the introduction of other extending depth of focus strategies.

Thus, the present invention provides a lens apparatus, systems and methods that provide both a monocular and binocular solution to correct presbyopia, and therefore provide improved vision at all of near, far and intermediate distances.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts, and in which:

FIG. 1 is a diagram illustrating the relevant structures and distances of the human eye;

FIG. 2 is a plot illustrating real outcomes in accordance with the present invention when applied monocularly;

FIG. 3 is a diagram illustrating aspects of a method in accordance with the present invention;

FIG. 4 is a diagram illustrating aspects of a computerized implementation in accordance with the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical lenses, lens systems and lens design methods. Those of ordinary skill in the pertinent arts may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

The present invention is directed to an ophthalmic lens, such as an intraocular lens (IOL), a phakic IOL or a corneal implant, and other vision correction methodologies, such as laser treatments, and a system and method relating to same, for providing an amplification/attenuation of the patient's natural ocular aberration pattern. That concept may also be applied in order to induce customized monovision binocularly and therefore achieve good vision at a range of distances. The system and method may include, for example, an optimized binocular summation of the patient's two eyes.

The terms “power” or “optical power” are used herein to indicate the ability of a lens, an optic, an optical surface, or at least a portion of an optical surface, to redirect incident light for the purpose of forming a real or virtual focal point. Optical power may result from reflection, refraction, diffraction, or some combination thereof and is generally expressed in units of Diopters. One of skill in the art will appreciate that the optical power of a surface, lens, or optic is generally equal to the reciprocal of the focal length of the surface, lens, or optic, when the focal length is expressed in units of meters.

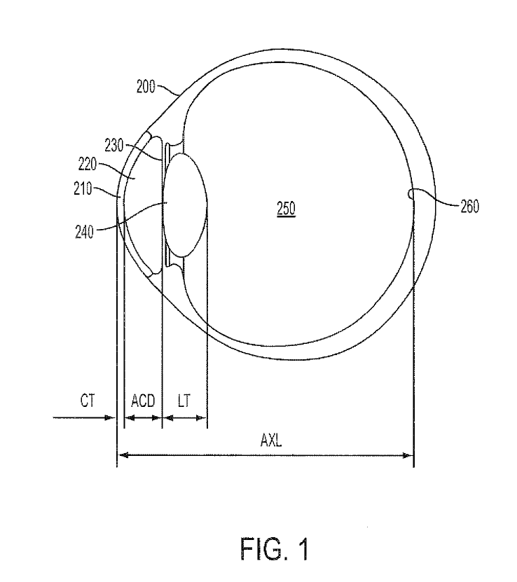

FIG. 1 is a schematic drawing of a human eye 200. Light enters the eye from the left of FIG. 1, and passes through the cornea 210, the anterior chamber 220, the iris 230 through the pupil, and enters lens 240. After passing through the lens, light passes through the posterior chamber 250, and strikes the retina 260, which detects the light and converts it to a signal transmitted through the optic nerve to the brain (not shown). Cornea 210 has corneal thickness (CT), which is the distance between the anterior and posterior surfaces of the center of the cornea. Anterior chamber 220 has anterior chamber depth (ACD), which is the distance between the posterior surface of the cornea and the anterior surface of the lens. Lens 240 has lens thickness (LT) which is the distance between the anterior and posterior surfaces of the lens. The eye has an axial length (AXL) which is the distance between the center of the anterior surface of the cornea and the fovea of the retina, where the image should focus.

The anterior chamber 220 is filled with aqueous humor, and optically communicates through the lens with the vitreous chamber, which occupies the posterior ⅘ or so of the eyeball and is filled with vitreous humor. The average adult eye has an ACD of about 3.15 mm, although the ACD typically shallows by about 0.01 mm per year. Further, the ACD is dependent on the accommodative state of the lens, i.e., whether the lens is focusing on an object that is near or far.

The quality of the image that reaches the retina is related to the amount of optical aberrations that every particular eye might present. The ocular surfaces that greatly contribute to increase the amount of eye aberrations are the cornea and the lens. Those skilled in the art might consider that although there are some aberration modes present on average in the population, e.g. spherical aberration, the ocular aberration pattern of each patient is unique.

The herein disclosed systems and methods are directed to selecting characteristics, such as optical power and a characteristic optical aberration pattern in order to provide an optimal vision outcome for patients suffering from presbyopia. An IOL comprises an optic, or clear portion, for focusing light, and may also include one or more haptics that are attached to the optic and may serve to center the optic under the pupil, for example, by coupling the optic to zonular fibers of the eye. In certain embodiments, distal ends of an IOL's haptics may be disposed within a plane, defined as the lens haptic plane (LHP). In various embodiments, a modeled eye with an IOL implanted may also include other information of the IOL, such as the location of IOL within eye as indicated, for example, by the post-implant ACD. The optic of the IOL has an anterior surface and a posterior surface, each having a particular shape that contributes to the refractive properties of the lens. Those skilled in the art will appreciate, in light of the discussion herein, that the base power of the optic may be calculated in order to achieve emmetropia for far distances.

The term “near vision,” as used herein, refers to vision provided by at least a portion of a lens 240, such as an IOL 240, wherein objects relatively close to the subject are substantially in focus on the retina of the subject eye. The term “near vision' generally corresponds to the vision provided when objects are at a distance from the subject eye of between about 25 cm to about 50 cm. The term “distant vision” or “far vision,” as used herein, refers to vision provided by at least a portion of lens/IOL 240, wherein objects relatively far from the subject are substantially in focus on the retina of the eye. The term “distant vision” generally corresponds to the vision provided when objects are at a distance of at least about 2 m or greater. As used herein, the “dominant eye” is defined as the eye of the patient that predominates for distant vision, as defined above. The term “intermediate vision,” as used herein, refers to vision provided by at least a portion of a lens, wherein objects at an intermediate distance from the subject are substantially in focus on the retina of the eye. Intermediate vision generally corresponds to vision provided when objects are at a distance of about 2 m to about 50 cm from the subject eye.

The current state of art for ophthalmic solutions is based on either not considering or correcting to some degree some corneal aberrations, such as spherical aberration or cylinder. However, to date, ophthalmic solutions are not designed with the consideration of the complete ocular aberration pattern as it was prior to the surgery.

As detailed herein, there is a neural adaption that allows for partially compensating the blur associated with patient's aberrations. Therefore, the patient's crystalline lens aberration pattern may be applied to the IOL in order to maintain the overall amount of ocular aberrations and then profit from the neural adaptation mechanism.

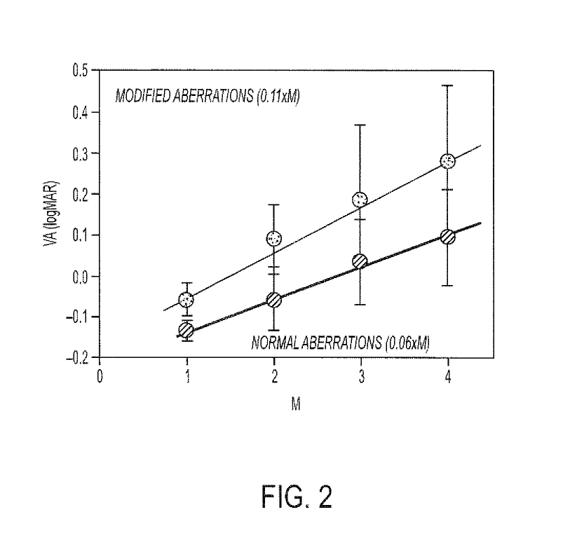

The inventors' research shows that this neural adaptation mechanism is in fact wider. An adaptive optics visual simulator (Fernández, et al. Opt. Lett. 2001) was used to measure the high contrast visual acuity, using SLOAN letters for a variety of aberration patterns in four normal subjects with paralyzed accommodation. Measurements were performed at the best focus position and with a 4-mm pupil diameter. The following aberration patterns were applied: the subject's natural aberrations and a modified aberration pattern calculated to provide the same optical quality (equivalent Strehl ratio) as that of the normal aberrations but with the Zernike aberration terms modified in a randomized fashion. For each case of aberration patterns, both normal and modified, visual acuity was also measured when the aberrations were scaled by constant factors (M=1,2,3,4). The results of these experiments are shown in FIG. 2.

FIG. 2 shows that although there was individual variability, the average visual acuity was −0.14 (log MAR) for normal aberrations (M=1). Visual acuity (in Log MAR) increased linearly as a function of increasing M with a slope value of 0.06. With modified aberrations, although having the same strehl ratio, visual acuity was reduced to −0.06 log MAR. For the case of modified aberrations Log MAR visual acuity increased at a higher rate (0.11 log MAR units per each M value). The variability was higher for the modified cases as compared to the normal aberration cases. Therefore, visual acuity was higher when subjects performed testing through their normal aberration patterns than with the modified case, although in both cases the retinal image quality was equivalent. The relative reduction of visual acuity as a function of the scaled aberration doubled for the case of modified aberrations. These results suggest that the neural adaptation to the high order aberrations also plays a role when these are scaled. While previous research (Artal et al. Journal of Vision, 2004, 4, 281-287) showed a subjective neural adaptation perceived sharpness, the results of our experiments show that neural adaptation also generates an increase in visual quality in terms of visual acuity.

The results provided by the research herein described show that from a practical point of view, it may be advantageous to induce aberrations by scaling the normal aberrations present in each subject's eye to, for example, extend depth of focus.

The present invention provides a system, method, apparatus or treatment that allows for attenuating or amplifying natural ocular aberrations. The attenuation of ocular aberrations is addressed in order to correct or partially correct overall eye aberrations. Those skilled in the art may appreciate that the partial correction of aberrations by a subject's scaled patterns is more advantageous than a partial correction with random residual, under the scope of the same concept herein described. The amplification of a patient's ocular aberrations may be addressed in order to increase depth of focus.

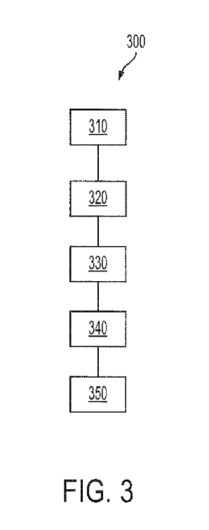

FIG. 3 presents a schematic view of the method 300 to achieve such a patient scaled aberration lens. At step 310 a measurement of the ocular aberrations is performed. From them, different scaled patterns can be calculated. At step 320, the tilts and decentration of the crystalline lens should also be measured. A visual testing can be performed at step 330 in order to determine the optimum scaling factor for a particular patient and a defined visual task. Once the scaled aberration pattern has been chosen, the IOL with the corresponding aberrations is designed at step 340, where IOL aberrations would be those resulting from subtracting the scaled pattern resulting from step 330, from corneal aberrations. The aberrations of the cornea can be obtained by measuring the patient's corneal topography (preferably anterior and posterior surface). The design might also compensate for those aberrations induced by the incision performed in the cornea to introduce the IOL. At step 350, the lens is implanted into the eye, during normal cataract surgery. In case asymmetrical aberrations are present, the IOL must be placed in a specific orientation (somewhat similar to toric IOLs). Different from toric IOLs, higher order asymmetrical IOLs according to this invention cannot be rotated by 180 degrees, which means that the orientation markings on the lens must be different at each side of the optic.

Although method 300 has been described with respect to IOLs, it can also be applied to other ophthalmic devices or solutions. By way of non limiting example, such ophthalmic correction might be a cornea or lens reshaping procedure, such as, for example using a picosecond or femtosecond laser. Laser ablation procedures can remove a targeted amount stroma of a cornea to change a cornea's contour and adjust for aberrations. In known systems, a laser beam often comprises a series of discrete pulses of laser light energy, with a total shape and amount of tissue removed being determined by a shape, size, location, and/or number of laser energy pulses impinging on a cornea.

In an alternative embodiment, the treatment may combine laser and cataract surgery. While cataract surgery results in IOLs implanted that may generate the desired lens power configuration, the attenuation or amplification of aberrations may be applied by laser techniques.

Such ophthalmic correction might also be a phakic lens that may be disposed either in front of the iris, behind the iris, or in the plane defined by the iris, at step 350. Alternatively, a corneal implant, for example, inserted within the stromal layer of the cornea. Likewise, the lens having the indicated characteristics may be a contact lens or another type of ophthalmic device or treatment that is used to provide or improve the vision of a subject. In yet another example, the lens may be an adjustable lens. In this case, the reshaping procedure is carried out post operatively. All these ophthalmic devices should present the scaled aberration pattern resulting from step 330 minus ocular aberrations.

The particular lenses discussed for use herein may be constructed of any commonly employed material or materials used for rigid optics, such as polymethylmethacrylate (PMMA), or of any commonly used materials for resiliently deformable or foldable optics, such as silicone polymeric materials, acrylic polymeric materials, hydrogel-forming polymeric materials, such as polyhydroxyethylmethacrylate, polyphosphazenes, polyurethanes, and mixtures thereof and the like. The material used preferably forms an optically clear optic and exhibits biocompatibility in the environment of the eye. However, portions of an optic used may alternatively be constructed of an at least partially opaque or scattering material, such as to selectively block or scatter light. Additionally, foldable/deformable materials are particularly advantageous for formation of implantable ones of ophthalmic lenses for use in the present invention, in part because lenses made from such deformable materials may be rolled, folded or otherwise deformed and inserted into the eye through a small incision.

In an alternative embodiment, if measurements of ocular aberrations and vision testing are not possible in the patient due to, e.g., the advanced stage of a cataract, the aberration pattern can be based on the aberrations induced by the cornea alone. In that case, the corneal topography may be measured, as well as the axial length of the eye. The ocular aberrations are then calculated using established methods for retrieving optical aberrations from corneal topography data (see e.g. Guirao A, Artal P. Corneal wave aberration from videokeratography: accuracy and limitations of the procedure. J Opt Soc Am A 2000;17(6):955-65). These ophthalmic devices or procedures should present the scaled aberration pattern resulting from these calculations.

An alternative solution is to introduce realistic patterns of eye aberrations. It has been shown that artificial combinations of similar amounts of Zernike but random signs produce lower MTF than actual Zernike sets in real eyes (J. S. McLellan, P. M. Prieto, S. Marcos, S. A. Burns, Effects of interactions among wave aberrations on optical image quality, Vision Research 46 (2006) 3009-3016). Therefore a database of aberrations patterns, created from real eye measurements with desired visual acuity might be used in such cases. From corneal measurements, the specific pattern for the patient might be created, when the method 300 is applied to design an IOL.

In another embodiment, the lens can be combined with multifocal, progressive and accommodating lenses.

In another embodiment, the lens or procedure is used for patients having high ocular aberrations; for example, in patients having keratoconus. In the proposed lens or procedure, the corneal aberrations of a keratoconus patient are reduced or compensated, while maintaining the patient's specific wavefront aberration pattern.

In an alternative embodiment, it can be decided to independently correct certain aberrations (e.g. spherical aberration) and leave all other aberrations proportional to the natural aberrations. This alternative is especially useful for patients having one or more dominating aberration terms.

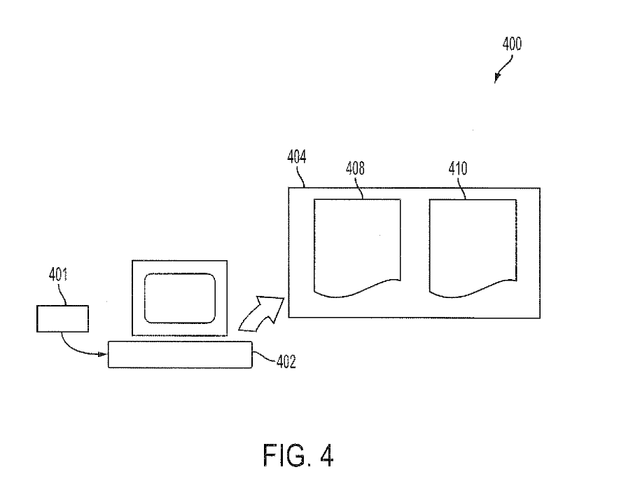

Those skilled in the art might appreciate that all relevant measurements on what the present invention is based may be performed by using instruments known in the art. However, an instrument comprising all needed measurements (ocular and corneal wavefront aberration measurements) as well as the needed calculations to get the particular treatment provided by 300 can be considered an apparatus of the present invention. An instrument can comprise a set of apparatuses, including a set of apparatuses from different manufacturers, configured such as to perform the necessary measurements and calculations. FIG. 4 is a block diagram illustrating the implementation of the present invention in a clinical system 400 comprised of one or more apparatuses capable of performing the calculations, assessments and comparisons discussed herein. The system 400 may include a biometric reader/simulator and/or like input 401, a processor 402, and a computer readable memory or medium 404 coupled to the processor 402. The computer readable memory 404 includes therein an array of ordered values 408 and sequences of instructions 410 which, when executed by the processor 402, cause the processor 402 to select and/or design the aspects discussed herein for association with a lens to be implanted into the eye, or reshaping to be performed on the eye, subject to the biometric readings/simulation at input 401. The array of ordered values 408 may comprise data used or obtained from and for use in design methods consistent with embodiments of the invention.

The sequence of instructions 410 may include one or more steps consistent with embodiments of the invention. In some embodiments, the sequence of instructions 410 includes applying calculations, customization, simulation, comparison, and the like.

The processor 402 may be embodied in a general purpose desktop, laptop, tablet or mobile computer, and/or may comprise hardware and/or software associated with inputs 401. In certain embodiments, the system 400 may be configured to be electronically coupled to another device, such as one or more instruments for obtaining measurements of an eye or a plurality of eyes. Alternatively, the system 400 may be adapted to be electronically and/or wirelessly coupled to one or more other devices

The scaled aberrations concept can also be used binocularly to generate customized binocular summation, in what the inventors have called “customized monovision”.

According to Sabesan, et al., (Impact of Correcting Higher Order Aberrations on Binocular Visual Performance and Summation, ARVO 2011, Program 4768/Session 464), the visual benefit of correcting higher order aberrations is higher monocularly than binocularly, and the summation factor decreases when all aberrations are corrected binocularly. Therefore, it may be assumed that the correction of higher order aberrations in only one eye in a binocular system is sufficient. Consequently, the second eye in the binocular system may be optimized for a task other than far, or near, vision. Moreover, according to Zheleznyak, et al., (Modified Monovision to Improve Binocular Through-Focus Visual Performance, ARVO Meeting Abstracts Apr. 22, 2011 52:2818), intermediate vision in conventional monovision may be improved by inducing certain amounts of spherical aberration in the non-dominant eye.

One may discern from these references and the teaching of the present invention that the aberration pattern at the dominant eye, i.e., the eye assessed for far vision in the instant binocular embodiments, may be attenuated, achieving a correction or partial correction for corneal aberrations of the dominant eye, thereby providing excellent far vision. The patient's natural aberrations at the non dominant eye, the eye assessed for near vision, may be amplified in order to increase depth of focus. Therefore, the proposed solution is a binocular application of the scaled aberration concept where the patient's aberrations are reduced in the dominant eye and increased in the non dominant eye.

Then, the flow diagram presented at FIG. 3 may be duplicated when customized monovision is targeted, with the only difference that the visual testing at step 330 should be performed binocularly in order to select the proper scaling factors, both in the dominant and non dominant eye, in order to cover the range of vergences demanded by the subject with the desired binocular visual acuity and contrast sensitivity.

In an alternative embodiment, the non dominant eye may receive a corresponding additional optical power, such as between +0.5 and +1.5 D. This extra defocus may also be customized according the visual testing at step 330.

In an alternative embodiment, other modifications may be applied to the non dominant eye, such as to improve intermediate vision. For example, an aberration or phase pattern may be introduced to extend the depth of focus of the non-dominant eye. Similarly, extended depth of focus profiles, i.e., diffractive profiles, may be employed with the non-dominant eye. Additionally, sets of fourth and sixth order spherical aberrations, such as may be generated by the optimization procedure of Dai (Optical Surface Optimization for the Correction of Presbyopia, Applied Optics, 45, 4184-4195), may be provided to the non-dominant eye. Still further, an asymmetrical aberration, with a specific angle, may be introduced. For example, it may be indicated that vertical coma gives better results than horizontal coma in the non-dominant eye for a particular patient.

Accordingly, the present method 300 may provide improved visual performance for a patient or group of patients at all distances. Further, this improved visual performance may at least partially eliminate halos and poor contrast vision, in part due to the avoidance of abrupt power changes necessary in available multifocal systems.

Yet further, lenses used according to the present invention may be aspheric or aspherical, and/or any type of toric design indicated to those skilled in the pertinent arts in light of the discussion herein. Moreover, a lens designed in accordance with method 300 may be employed with a bifocal lens or a trifocal lens, for example, in the non-dominant eye, and likewise a lens designed in accordance with step 330 may be employed with a bifocal lens or trifocal lens in the dominant eye.

The block diagram at FIG. 4 illustrating the implementation of scaled aberrations concept in a clinical system 400 may also be considered for selecting the optical patterns at step 300 which define customized monovision. In this particular case, the clinical measurements provided by the reader/simulator and/or like input 401, will be used to, by means of the array of ordered values 408 and sequences of instructions 410 which, when executed by the processor 402, cause the processor 402 to select and/or design the aspects discussed herein for association with a lens to be implanted into the eye, or reshaping to be performed on the eye, subject to the biometric readings/simulation at input 401. The array of ordered values 408 may comprise data used or obtained from and for use in design methods consistent with embodiments of the invention. For example, the array of ordered values 408 may comprise one or more desired binocular visual outcomes, parameters of an eye model based on one or more measured characteristics of each eye, and/or data related to a lens, lenses, and/or reshaping procedures.

The sequence of instructions 410 may include one or more steps consistent with embodiments of the invention. In some embodiments, the sequence of instructions 410 includes applying calculations, customization, simulation, comparison, and the like.

The processor 402 may be embodied in a general purpose desktop, laptop, tablet or mobile computer, and/or may comprise hardware and/or software associated with inputs 401. In certain embodiments, the system 500 may be configured to be electronically coupled to another device, such as one or more instruments for obtaining measurements of an eye or a plurality of eyes. Alternatively, the system 400 may be adapted to be electronically and/or wirelessly coupled to one or more other devices.

Although the invention has been described and pictured in an exemplary form with a certain degree of particularity, it should be understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A method of designing an ophthalmic lens to correct presbyopia comprising scaling a patient's ocular aberration pattern.

2. The method of claim 1, where the patient's ocular aberration pattern is attenuated to correct or partially correct a patient's ocular aberrations.

3. The method of claim 1, where the patient's ocular aberration pattern is amplified to increase depth of focus.

4. The method of claim 1, where the patient's ocular aberration pattern is based on the cornea alone.

5. The method of claim 4, where the patient's ocular aberration pattern is attenuated to correct or partially correct a patient's ocular aberrations.

6. The method of claim 4, where the patient's ocular aberration pattern is amplified to increase depth of focus.

7. A method of designing an ophthalmic lens to correct presbyopia comprising scaling an aberration pattern derived from a database of aberrations patterns created from real eye measurements with a desired visual acuity.

8. The method of claim 7, where the ocular aberration pattern is attenuated to correct or partially correct a patient's ocular aberrations.

9. The method of claim 7, where the ocular aberration pattern is amplified to increase depth of focus.

10. A method for inducing customized monovision binocularly comprising:
obtaining an optimized binocular summation of both eyes of the patient, the optimized binocular summation comprising natural aberrations of the patient, a binocular measure of the patient, and changes in the dominant and non dominant eye measurement due to the natural aberrations of the patient;
designing a first lens solution to provide at least substantial emmetropy; and
designing a second lens solution to provide an extension of depth of focus.

11. The method of claim 10, wherein the first and/or second lens solution is selected from the group consisting of intraocular lenses, phakic IOLs, corneal inlays, and laser reshaping procedures.

12. A lens solution for correcting presbyopia comprising: scaling a patient's ocular aberration pattern; increasing the patient's natural ocular aberrations in one eye; and
decreasing the patient's natural ocular aberration in the fellow eye.

13. The method of claim 12, wherein the lens solution is selected from the group consisting of intraocular lenses, phakic IOLs, corneal inlays, and laser reshaping procedures.
